(19) United States
(12) Patent Application Publication
(10) Pub. No.: US 2019/0301716 A1
(43) Pub. Date: Oct. 3, 2019

(54) LUMINAIRE

(71) Applicant: YU LUO, SHENZHEN (CN)

(72) Inventor: YU LUO, SHENZHEN (CN)

(21) Appl. No.: 15/941,940

(22) Filed: Mar. 30, 2018

(51) Int. Cl. F21V 23/00; F21V 19/00; F21V 29/15

(52) U.S. Cl. CPC F21V 23/009; F21V 29/15; F21V 19/006

(57) ABSTRACT

A luminaire is disclosed. The luminaire includes a light socket, at least one heat insulation sheet, and at least one light emitting module. The heat insulation sheet is arranged between the light socket and the light emitting module. Thus heat from a driver power in the light socket and heat from the light emitting module will not be affected by each other. The light socket further includes a main body and a case made from metal. The case is mounted on the main body for fixing the main body on the light emitting module and being subject to gravity force of the light emitting module. Thereby the problem of deformation of the main body caused by the gravity force of the light emitting module is solved when the luminaire is used at high temperature. Thus the service life of the luminaire is extended.

### BACKGROUND OF THE INVENTION

### Field of the Invention

The present invention relates to a luminaire, especially to a removable luminaire with internal thermal insulation.

Lights and luminaires are deeply interwoven with our lives.

They make the lives much more convenient. Along with the ever-changing technology, there are various luminaires available on the market now and each has its own features. No matter incandescent light bulbs, fluorescent lamps, metal halide lamps, external electrode fluorescent lamps, compact fluorescent lamps, and LED modules for lighting, all have their own Photoelectric Performance, safety performance, environmental performance and price-performance ratio. LED has great potential in lighting field. The LED lighting applications and market shares are increased along with well-developed LED technology and lower cost of the LED products.

In the future, besides luminous efficacy, other factors of the lighting source such as lighting effect, visual comfort, biological effects, safety and environmental performance, resource consumption, etc. should also be considered. The incandescent lamps and energy-saving light bulbs used for public lighting or household lighting available on the market are gradually replaced by LED owing to low power consumption and long service life of the LED. The LED products are evolved and developed rapidly.

The conventional high intensity discharge light has a compatibility problem. Besides self-ballasted mercury vapor light, light bulbs in the high intensity discharge (HID) lamps need to work with electronic ballasts. There are two types of ballasts. One is CWI (Constant Wattage Isolated) ballast that requires an ignitor to provide a high-voltage electric arc for starting the lamp. The other is CWA (Constant Wattage Autotransformer) ballast that includes a capacitor in series with the lamp. To start the lamp requires no high voltage. In the HID lamp, a specific voltage is required to start so that the HID lamp is unable to connect to mains electricity. Thereby LED are more flexible and more widely applied to different fields.

Moreover, a driver power and electronic components in the luminaire have their own limits on temperature. The glass case is used at temperature below 250° C. while the electronic components work at temperature below 105° C. That means the temperature of the electronic components is too high and the LED luminaire is easily damaged once heat is transferred from the driver power to the electronic components. If the heat is transferred from the electronic components to the driver power, abnormal temperature in the driver power occurs. These conditions have negative effect on the luminaire. The conventional techniques use a certain amount of metal (such as aluminum alloy) over a certain area to conduct and dissipate heat generated by the electronic components and the driver power. The heat dissipation member made from metal leads to increased overall weight of the LED luminaire and further affects its use. The overall temperature resistance is also weaker than the conventional luminaire with glass bulbs. Moreover, the use of the metal for heat dissipation makes the direction the heat flows become more uncertain.

Not all LED luminaires are installed vertically to the ground. Among the luminaires directed parallel to the ground, especially those arranged with a large amount of light sources, plastic material between the electronic components and the power box can't withstand the weight of the light sources. Thus the luminaire is easy to have failure, damages or deformation. Therefore the service life of the luminaire is significantly reduced.

In order to solve the shortcomings of the conventional luminaire, how to dissipate heat from the electronic components and the driver power effectively and also minimize heat transfer therebetween, the overall weight control, and the improvement of durability have become important issues. Thus there is room for improvement and there is a need to provide a luminaire that solves the problems mentioned above.

### SUMMARY OF THE INVENTION

Therefore it is a primary object of the present invention to provide a luminaire that reduces heat transfer between a driver power and electronic components.

It is another object of the present invention to provide a luminaire in which not only strength and stiffness of a driver and electronic components are improved, deformation and damage problems caused by abnormal temperature or its own weight can also be solved.

In order to achieve the above objects, a luminaire according to the present invention includes a light socket, at least one heat insulation sheet disposed on a top surface of the light socket, and at least one first light emitting module arranged over the heat insulation sheet. The light socket includes a case and a fixing end set on the edge of a top surface of the case. A first fixing part is arranged at the edge of the heat insulation sheet. One end of the first light emitting module is provided with a second fixing part which is fixed on the fixing end together with the first fixing part.

The light socket further includes a main body. A third fixing part is disposed on the edge of a top surface of the main body and is fixed on the fixing end. A driver power is mounted in the main body and is electrically connected to the first light emitting module.

The heat insulation sheet includes a first through hole while the first light emitting module has a second through hole. A wire is passed through the first through hole and the second through hole for connecting the driver power and the first light emitting module.

The first light emitting module further includes a first light base, a first light panel, and a first lampshade. The first light base has a first light trough and the first light panel is mounted in the first light trough of the first light base while the first lampshade that covers the first light panel is set on the first light base.

The first lampshade includes a plurality of locking members on two sides thereof while a plurality of locking holes corresponding to the locking members respectively is disposed on the first light base and located around the first trough. The locking members of the first lampshade are fastened with the locking holes of the first light base correspondingly.

The first light emitting module further includes a first heat dissipation part that is disposed on one side of the first light base, opposite to the side of the first light base arranged with the first light trough.

The first heat dissipation part includes a plurality of heat dissipation fins that is arranged in parallel.

The luminaire further includes a second light emitting module with a first connecting part while a first connecting end is disposed on the other end of the first light emitting module. The second light emitting module is fixed on and connected to the first light emitting module by the first connecting part and the first connecting end connected to each other.

The second light emitting module further includes a second light base, a second light panel, and a second lampshade. The second light base has a second light trough and the second light panel is mounted in the second light trough of the second light base while the second lampshade that covers the second light panel is set on the second light base.

The second light emitting module further includes a second heat dissipation part that is disposed on one side of the second light base, opposite to the side of the second light base arranged with the second light trough.

The second heat dissipation part includes a plurality of heat dissipation members that is arranged circularly.

In order to achieve the above objects, a luminaire according to the present invention includes a light socket, at least one heat insulation sheet, and at least one first light emitting module. The light socket includes a main body and a case. A driver power is mounted in the main body and the case is covering and mounted on the main body. The heat insulation sheet is disposed on a top surface of the main body and further including a first through hole. The first light emitting module is arranged over the heat insulation sheet and is electrically connected to the driver power through the first through hole.

A fixing end is set on the edge of the case and a first fixing part is arranged at the edge of the heat insulation sheet. The first light emitting module further includes a second fixing part and a third fixing part is arranged at the edge of a top surface of the main body. The first fixing part, the second fixing part and the third fixing part are all fixed on the fixing end.

The first light emitting module further includes a second through hole. A wire is passed through the first through hole and the second through hole for electrically connection between the driver power and the first light emitting module.

The first light emitting module includes a first light base, a first light panel, and a first lampshade. The first light base has a first light trough and the first light panel is mounted in the first light trough while the first lampshade that covers the first light panel is set on the first light base.

A plurality of locking members is arranged at two sides of the first lampshade while the first light base includes a plurality of locking holes corresponding to the locking members respectively and located around the first trough. The locking members of the first lampshade are locked with the locking holes of the first light base correspondingly.

The first light emitting module further includes a first heat dissipation part that is mounted on one side of the first light base, opposite to the side of the first light base arranged with the first light trough.

The first heat dissipation part includes a plurality of heat dissipation fins that is arranged in parallel.

The luminaire further includes a second light emitting module with a first connecting part while a first connecting end is mounted on the other end of the first light emitting module. The second light emitting module is fixed on and connected to the first light emitting module by the first connecting part connected to the first connecting end.

The second light emitting module further includes a second light base, a second light panel, and a second lampshade. A second light trough is formed on the second light base and the second light panel is mounted in the second light trough of the second light base while the second lampshade that covers the second light panel is disposed on the second light base.

The second light emitting module further includes a second heat dissipation part that is arranged at one side of the second light base, opposite to the side of the second light base provided with the second light trough.

The second heat dissipation part includes a plurality of heat dissipation members that is disposed circularly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view of an embodiment according to the present invention;

FIG. 2 is another explosive view of an embodiment according to the present invention;

FIG. 3 is a schematic drawing showing structure of a light socket of an embodiment according to the present invention;

FIG. 4 is a schematic drawing showing structure of a heat insulation sheet of an embodiment according to the present invention;

FIG. 5 is a schematic drawing showing structure of heat insulation sheets of an embodiment according to the present invention.

### DETAILED DESCRIPTION OF THE PREFERRED EMBODIMENT

In order to learn the purposes, features and functions of the present invention, please refer to the following embodiments and related description.

A luminaire of the present invention is provided for solving the problems of the conventional LED luminaires such as heat transfer between the electronic components and the light source, abnormal temperature, over-weight of the light emitting module, strength and stiffness, durability, etc.

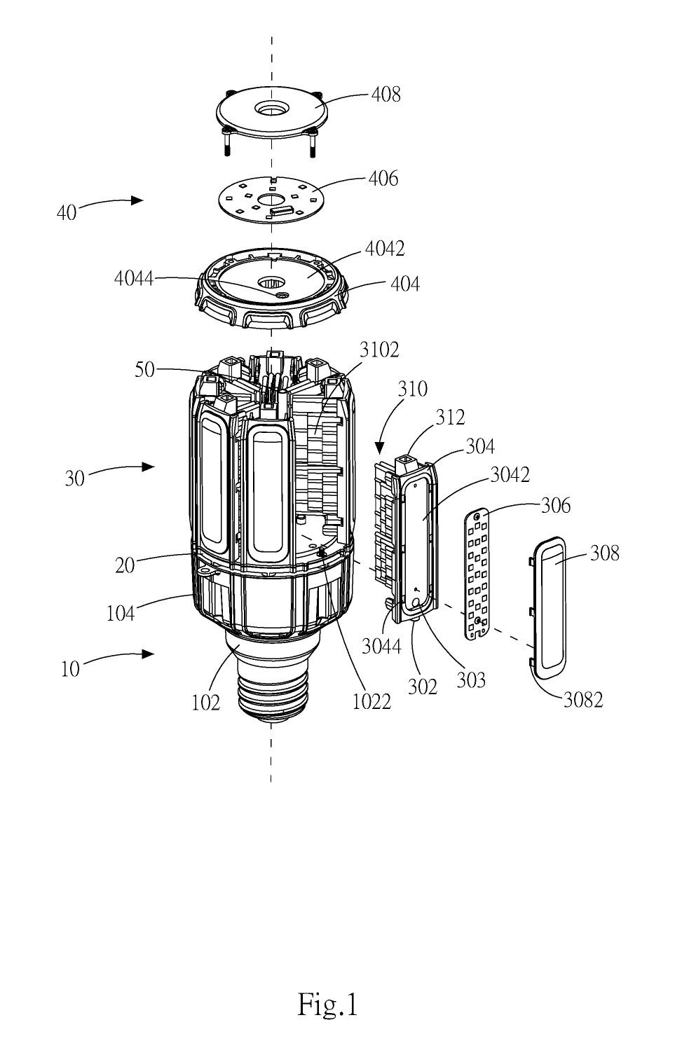

Refer to FIG. 1, a light of the present invention includes a light socket 10, at least one heat insulation sheet 20, at least one first light emitting module 30, and a second light emitting module 40. The heat insulation sheet 20 is fixed between the light socket 10 and the first light emitting module 30 while the second light emitting module 40 is fixed on and connected to the first light emitting module 30.

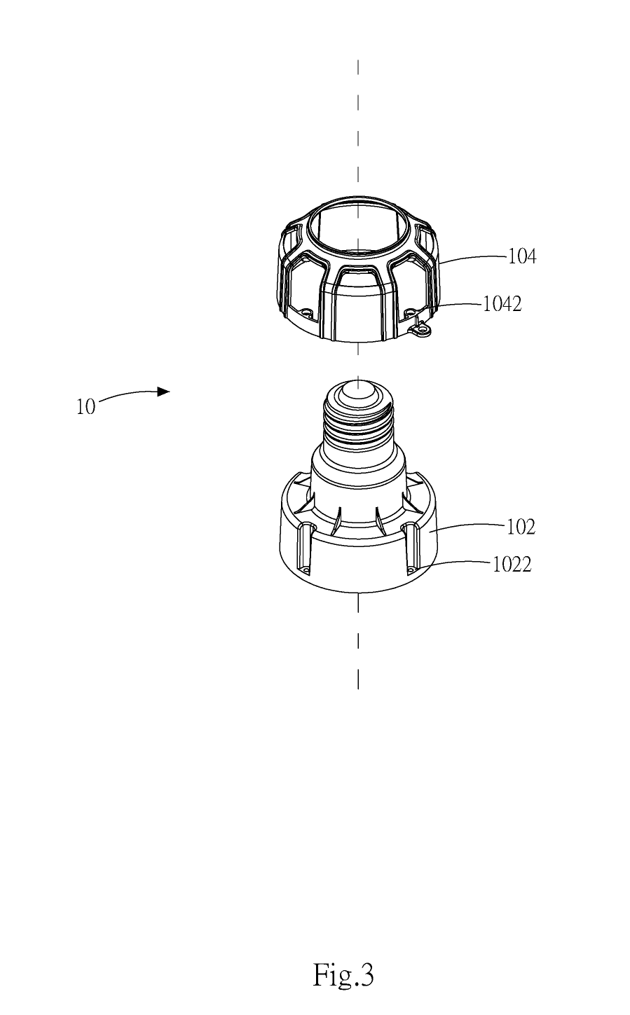

Refer to FIG. 3, the light socket 10 consists a main body 102 and a case 104. A driver power (not shown in figure) is mounted in the main body 102. The case 104 is mounted and fixed on the main body 102 and on an edge of a top surface set a fixing end 1042.

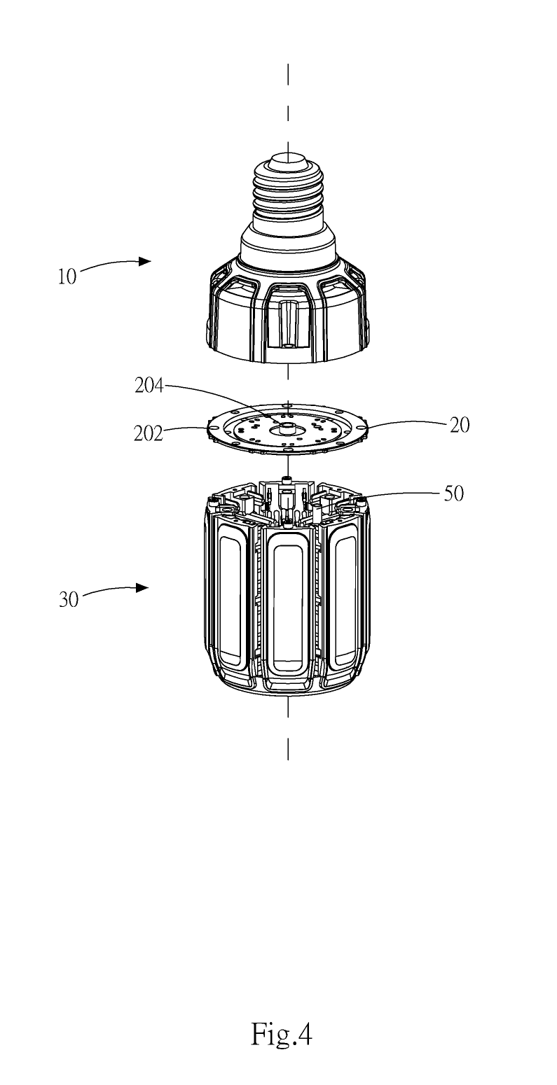

Refer to FIG. 4, there is one heat insulation sheet 20 in this embodiment. The heat insulation sheets 20 can be stacked one on top of the other if there is a plurality of heat insulation sheets 20. On an edge of the heat insulation sheet 20 is set a first fixing part 202 and a first through hole 204 for electrical connection.

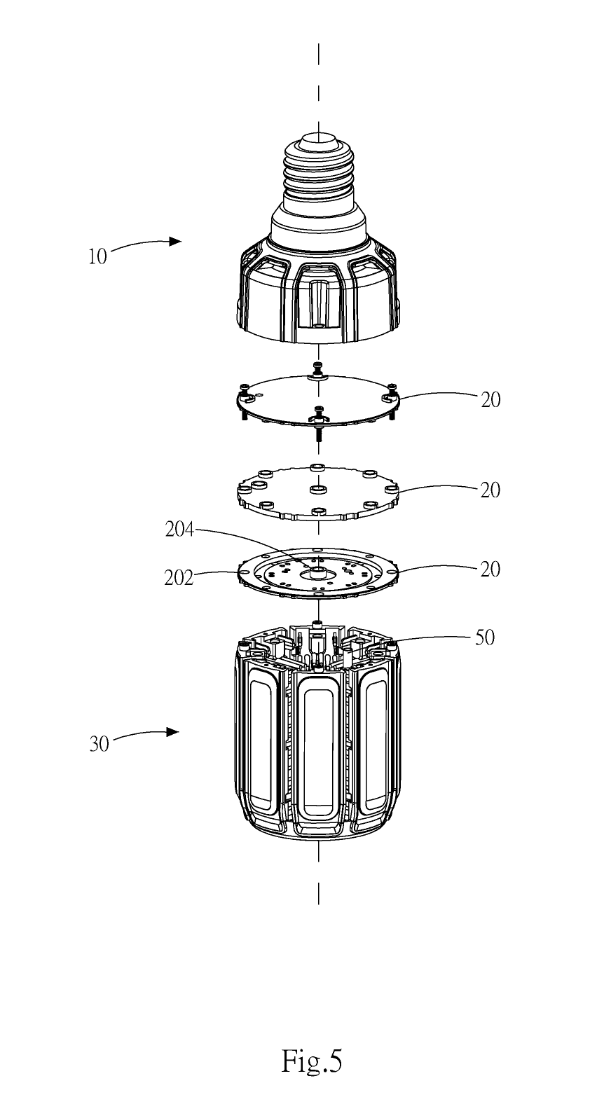

Refer to FIG. 5, there are more than two heat insulation sheets 20. The upper and the lower heat insulation sheets 20 are connected by the first fixing parts 202 fixed with each other and a wire is passed through the first through hole 204 thereof. The number of the heat insulation sheets 20 can be adjusted according to user's requirements.

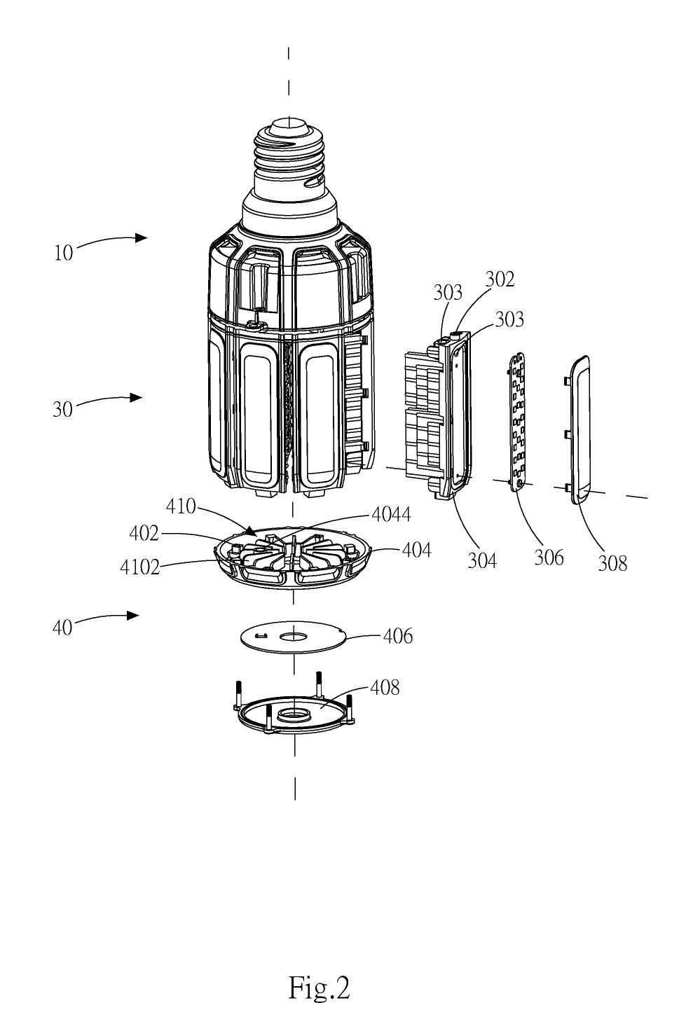

Refer to FIG. 1 and FIG. 2, a luminaire according to the present invention includes eight sets of the first light emitting module 30 circularly disposed over the heat insulation sheet 20. The number of the first light emitting module 30 is determined by the operation condition. The first light emitting module 30 consists of a second fixing part 302, a first light base 304, a first light panel 306, a first lampshade 308, a first heat dissipation part 310, and a first connecting end 312. The second fixing part 302 is disposed on a bottom surface of the first light emitting module 30 and including a second through hole 303 for electrical connection. A third fixing part 1022 is arranged at the edge of a top surface of the main body 102. The first fixing part 202, the second fixing part 302 and the third fixing part 1022 are all fixed on the fixing end 1042. The wire is passed through the second through hole 303 for electrical connection and connected to the first light panel 306. The first light base 304 further includes a first light trough 3042 and a plurality of locking holes 3044 mounted therearound. The first light panel 306 is mounted in the first light trough 3042 and the wire is connected to the first light panel 306. The first lampshade 308 that covers the first light panel 306 is set on the first light base 304 and further including a plurality of locking members 3082 on two sides thereof. The locking members 3082 are arranged corresponding to the locking holes 3044 so as to be fastened and fixed by each other. The first heat dissipation part 310 is disposed on one side of the first light base 304, opposite to the side of the first light base 304 arranged with the first light trough 304 and further including a plurality of heat dissipation fins 3102 that is arranged in parallel. The first connecting end 312 is set on a lateral side of a top surface of the first light emitting module 30.

Still refer to FIG. 1 and FIG. 2, the second light emitting module 40 is composed of a first connecting part 402, a second light base 404, a second light panel 406, a second lampshade 408, and a second heat dissipation part 410. The first connecting part 402 is arranged at a bottom surface of the second light emitting module 40 to be connected to and fixed on the first connecting end 312. The second light base 404 further includes a second light trough 4042 and a third through hole 4044 for electrical connection. The second light panel 406 is mounted in the second light trough 4042 while the second lampshade 408 that covers the second light panel 406 is arranged at the second light base 404. The second heat dissipation part 410 is disposed on one side of the second light base 404, opposite to the side of the second light base 404 provided with the second light trough 404 and further including a plurality of heat dissipation members 4102 that is arranged circularly. The first connecting end 312 is set on a lateral side of a top surface of the first light emitting module 30. An electrical conduit 50 is passed through the third through hole 4044 and the heat insulation sheet 20 while the wire is inserted through the electrical conduit 50 and the third through hole 4044 to connected to the second light panel 406.

Refer to FIG. 1 and FIG. 3, the main body 102 is made from plastic. Thus electrical insulation is achieved when the present luminaire is connected to mains electricity or other electrical power sources. Thus the safety operation of the luminaire and internal wires are ensured. Protection against electric shock is provided and the safety is increased. The case 104 is made from strong materials such as metal. In this embodiment, the case 104 is made from metal. The case 104 is fit on the main body 102 and is able to be a meshed structure, a cut out structure, or a frame structure. In this embodiment, the case 104 is having a meshed structure. A fixing end 1042 of the case 104 is fixed on the second fixing part 302. The main body 102 is made from plastic so that it is easy to have certain risks such as failure while being used under abnormal conditions such as at high temperature. The main body 102 is easy to get deformed and damaged owing to the weight of the luminaire when the luminaire is used in parallel to the ground. The arrangement of the metal case 104 can bear the stress resulted from the weight of the first light emitting module/modules 30. The deformation and damages of the main body 102 can be further avoided. Moreover, the thermal conductivity of the meal can also transfer the heat generated by the driver power inside the main body 102 to the atmosphere outside to reduce the temperature of the luminaire.

Refer to FIG. 1 and FIG. 4, the heat insulation sheet 20 is fixed between the light socket 10 and the first light emitting module 30 for insulating heat from the driver power, heat from the first light emitting module 30 and heat from the second light emitting module 40. That means the heat insulation sheet 20 provides thermal insulation for reducing heat transfer between the driver power in the light socket 10 and the first and the second light emitting modules 30, 40.

Refer to FIG. 1, each first light emitting module 30 is independent of each other when the luminaire includes a plurality of first light emitting modules 30. The design ensures a certain gap between the two adjacent first light emitting modules 30 so that the heat can be dissipated in time.

In summary, the luminaire according to the present invention mainly includes a light socket, at least one heat insulation sheet, at least one first light emitting module, and a second light emitting module. A case is mounted on the light socket and used to fix and connect the first light emitting module. Compared with the structure of the conventional luminaire in which the first light emitting module is connected to and fixed on the main body of the light socket, the structure of the present luminaire solves the problem of shortened service life caused by deformation and damage of the light socket. The light socket is easily deformed and damaged owing to the weight of the luminaire while the luminaire is used at high temperature. The arrangement of the heat insulation sheet between the light socket and the light emitting modules can reduce heat transfer between the driver power in the light socket and the light emitting modules. Thereby the service life of the luminaire is increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A luminaire comprising:
a light socket having
a case and
a fixing end set on an edge of a top surface of the case;
at least one heat insulation sheet disposed on a top surface of the light socket and including a first fixing part arranged at an edge thereof; and
at least one first light emitting module arranged over the heat insulation sheet and having a second fixing part on one end thereof;
wherein the second fixing part and the first fixing part are fixed on the fixing end.

2. The device as claimed in claim 1, wherein the light socket further includes a main body; a third fixing part is disposed on an edge of a top surface of the main body and is fixed on the fixing end; a driver power is mounted in the main body and is electrically connected to the first light emitting module.

3. The device as claimed in claim 1, wherein the heat insulation sheet includes a first through hole and the first light emitting module includes a second through hole; a wire is passed through the first through hole and the second through hole for connecting the driver power and the first light emitting module.

4. The device as claimed in claim 1, wherein the first light emitting module further includes a first light base, a first light panel, and a first lampshade;
the first light base is arranged with a first light trough and the first light panel is mounted in the first light trough of the first light base; the first lampshade that covers the first light panel is set on the first light base.

5. The device as claimed in claim 4, wherein a plurality of locking members is arranged at two sides of the first lampshade while a plurality of locking holes corresponding to the locking members respectively is disposed on the first light base and located around the first trough; the locking members of the first lampshade are mounted into the locking holes of the first light base respectively.

6. The device as claimed in claim 4, wherein the first light emitting module further includes a first heat dissipation part; the first heat dissipation part is disposed on one side of the first light base, opposite to the side of the first light base arranged with the first light trough.

7. The device as claimed in claim 6, wherein the first heat dissipation part includes a plurality of heat dissipation fins; the heat dissipation fins are arranged in parallel.

8. The device as claimed in claim 1, wherein the luminaire further includes a second light emitting module having a first connecting part; a first connecting end is disposed on the other end of the first light emitting module; the second light emitting module is fixed on and connected to the first light emitting module by the first connecting part connected to the first connecting end.

9. The device as claimed in claim 8, wherein the second light emitting module further includes a second light base, a second light panel, and a second lampshade; a second light trough is formed on the second light base and the second light panel is mounted in the second light trough of the second light base; the second lampshade that covers the second light panel is set on the second light base.

10. The device as claimed in claim 9, wherein the second light emitting module further includes a second heat dissipation part; the second heat dissipation part is disposed on one side of the second light base, opposite to the side of the second light base arranged with the second light trough.

11. The device as claimed in claim 10, wherein the second heat dissipation part includes a plurality of heat dissipation members; the heat dissipation members are arranged circularly.

12. A luminaire comprising:
a light socket that includes a main body with a driver power mounted therein, and a case covering and mounted on the main body;
at least one heat insulation sheet disposed on a top surface of the main body and having a first through hole thereof; and
at least one first light emitting module that is arranged over the heat insulation sheet and is electrically connected to the driver power through the first through hole.

13. The device as claimed in claim 12, wherein a fixing end is set on an edge of the case and a first fixing part is arranged at an edge of the heat insulation sheet; the first light emitting module further includes a second fixing part and a third fixing part is arranged at an edge of a top surface of the main body; the first fixing part, the second fixing part and the third fixing part are fixed on the fixing end.

14. The device as claimed in claim 12, wherein the heat insulation sheet includes a first through hole and the first light emitting module includes a second through hole; a wire is passed through the first through hole and the second through hole for connecting the driver power and the first light emitting module.

15. The device as claimed in claim 12, wherein the first light emitting module further includes a first light base, a first light panel, and a first lampshade; the first light base is arranged with a first light trough and the first light panel is mounted in the first light trough of the first light base; the first lampshade that covers the first light panel is set on the first light base.

16. The device as claimed in claim 15, wherein a plurality of locking members is arranged at two sides of the first lampshade while a plurality of locking holes corresponding to the locking members respectively is disposed on the first light base and located around the first trough; the locking members of the first lampshade are mounted into the locking holes of the first light base respectively.

17. The device as claimed in claim 15, wherein the first light emitting module further includes a first heat dissipation part; the first heat dissipation part is disposed on one side of the first light base, opposite to the side of the first light base arranged with the first light trough.

18. The device as claimed in claim 17, wherein the first heat dissipation part includes a plurality of heat dissipation fins; the heat dissipation fins are arranged in parallel.

19. The device as claimed in claim 12, wherein the luminaire further includes a second light emitting module having a first connecting part; a first connecting end is disposed on the other end of the first light emitting module; the second light emitting module is fixed on and connected to the first light emitting module by the first connecting part connected to the first connecting end.

20. The device as claimed in claim 19, wherein the second light emitting module further includes a second light base, a second light panel, and a second lampshade; a second light trough is formed on the second light base and the second light panel is mounted in the second light trough of the second light base; the second lampshade that covers the second light panel is set on the second light base.

21. The device as claimed in claim 20, wherein the second light emitting module further includes a second heat dissipation part; the second heat dissipation part is disposed on one side of the second light base, opposite to the side of the second light base arranged with the second light trough.

22. The device as claimed in claim 21, wherein the second heat dissipation part includes a plurality of heat dissipation members; the heat dissipation members are arranged circularly.
